(19) United States
(12) Patent Application Publication
(10) Pub. No.: US 2011/0282938 A1
(43) Pub. Date: Nov. 17, 2011

(54) METHOD OF PROVIDING SEAMLESS INTEROPERABILITY BETWEEN WEB BROWSER AND APPLICATION IN SINGLE-THREADED ENVIRONMENT AND APPARATUS FOR PERFORMING THE SAME

(75) Inventors: Seung-Hyun KIM, Daejeon (KR); Young Seob CHO, Daejeon (KR); Sang Rae CHO, Daejeon (KR); Dae Seon CHOI, Daejeon (KR); Jong-Hyouk NOH, Daejeon (KR); Soo Hyung KIM, Daejeon (KR); Seung Hun JIN, Daejeon (KR)

(73) Assignee: Electronics and Telecommunications Research Institute, Daejeon (KR)

(21) Appl. No.: 13/106,685

(22) Filed: May 12, 2011

(30) Foreign Application Priority Data
May 12, 2010 (KR) 10-2010-0044460
Dec. 23, 2010 (KR) 10-2010-0133770

(51) Int. Cl. G06F 15/16

(52) U.S. Cl. 709/203

(57) ABSTRACT

An apparatus for providing a seamless interoperability between a web browser and an application in a single-threaded environment in a user terminal includes: a web service server configured to provide a web service via a network, based on the seamless interoperability between the web browser and the application; and a user terminal configured to receive a parameter for the web service in communication with the web service server via the network, call the application onto a first tab in the web browser, receive a return response of the application onto a second tab in the web browser to transmit the received return response to the web service server, and request the web service server to provide a result web page while executing the first tab when the second tab is closed.

### CROSS-REFERENCE(S) TO RELATED APPLICATION(S)

The present invention claims priority of Korean Patent Applications No. 10-2010-0044460, filed on May 12, 2010 and No. 10-2010-0133770, filed on Dec. 23, 2010, which are incorporated herein by reference.

### FIELD OF THE INVENTION

The present invention relates to an apparatus and a method for providing seamless interoperability between a web browser and an application to be executed in a single-threaded environment by a user terminal.

### BACKGROUND OF THE INVENTION

In a single-threaded environment, only one application is driven at a specific time. For example, when an application ‘A’ is driven in the single-threaded environment, only the application ‘A’ runs in a system and a user may see a screen displayed by the drive of the application ‘A’.

At this time, if an application ‘B’ is called, the application ‘A’ stops running at the calling time and the application ‘B’ may be executed on an uppermost layer.

After that, the stopped application ‘A’ may be re-driven when the application ‘B’ finishes running autonomously or is stopped by manual operation. Meanwhile, if the application ‘B’ calls the application ‘A’, not the exact previously driven application ‘A’ but another application ‘A’ is executed.

In a case of a multimedia terminal such as a smart phone driven by a single-thread, an application can be called through a first tab in a web browser and a response of the called application is not transmitted to the first tab but to a second tab which is additionally generated. Thus, a response page is driven on the second tab and is positioned at the uppermost layer.

Since the first tab with which has called the application stops and maintains the state, operation reflecting the response of the application is disabled, state that the stopped tabs are overlapped brings a user visual confusion, and the user must close the tabs inconveniently one by one by manual.

FIG. 4 illustrates an example of an activated tab and a stopped tab on a web browser that is executed in a user terminal.

### SUMMARY OF THE INVENTION

In view of the above, the present invention provides a method of allowing a web browser in a single-threaded environment to drive an application on a first tab in the web browser and to re-load onto the first tab a web page reflecting a response of the application.

Here, the method is implemented such that the response of the application is transmitted to a server via a separate tab but the separate tab is automatically closed after the transmission, and the first tab is then positioned at the uppermost layer to automatically request a service to the server. A script for driving or closing the tabs may use a standard javascript function.

In accordance with a first aspect of the present invention, there is provided an apparatus for providing a seamless interoperability between a web browser and an application in a single-threaded environment in a user terminal, the apparatus including:

a web service server configured to provide a web service via a network, based on the seamless interoperability between the web browser and the application; and

a user terminal configured to receive a parameter for the web service in communication with the web service server via the network, call the application onto a first tab in the web browser, receive a return response of the application onto a second tab in the web browser to transmit the received return response to the web service server, and request the web service server to provide a result web page while executing the first tab when the second tab is closed.

In accordance with a second aspect of the present invention, there is provided a method for providing a seamless interoperability between a web browser and an application in a single-threaded environment in a user terminal, the method including:

requesting a web service through a first tab in the web browser;

calling the application when receiving a request for execution result information of the application;

stopping the execution of the first tab;

returning a response of the application through a second tab in the web browser;

activating the first tab after closing the second tab; and

requesting the web service through the first tab once more.

In accordance with a third aspect of the present invention, there is provided a method for providing a seamless interoperability between a web browser and an application to be executed in a single-threaded environment by a user terminal in a computer networking system including the user terminal and a web service server, the method including:

receiving a request for a web service from a first tab in the web browser of the user terminal;

requesting execution result information of the application to the user terminal;

receiving a response of the application from a second tab in the web browser of the user terminal to handle the response of the application;

transmitting a script for closing the second tab to the user terminal; and

checking the response of the application when the web service is again requested from the first tab of the user terminal.

### BRIEF DESCRIPTION OF THE DRAWINGS

The objects and features of the present invention will become apparent from the following description of embodiments given in conjunction with the accompanying drawings, in which:

FIG. 1 is a block diagram of illustrating a computer networking system adapted for providing a seamless interoperability between a web browser and an application in a single-threaded environment in accordance with an embodiment of the present invention;

FIG. 2 is a block diagram illustrating relationships among a web service server, a web browser, and an application shown in FIG. 1;

FIG. 3 is a sequence diagram illustrating the seamless interoperability between the web browser and the application in the single-threaded environment in accordance with the embodiment of the present invention; and

FIG. 4 is a view for illustrating a conventional troubleshooting generated during interoperability between the web browser and the application in the single-threaded environment.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described in detail with reference to the accompanying drawings which form a part hereof.

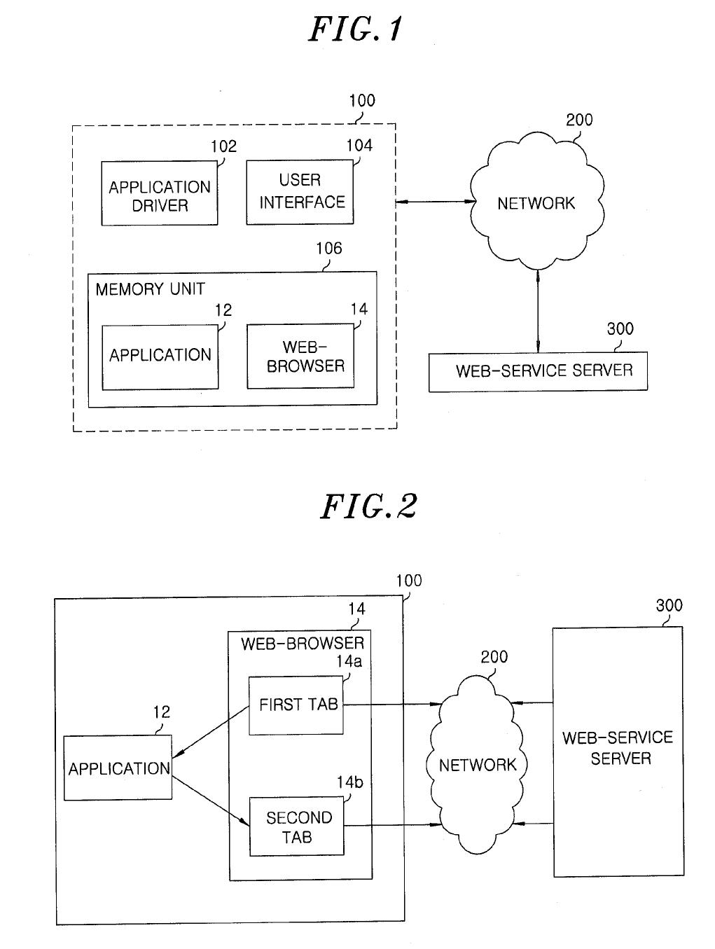

FIG. 1 is a block diagram of illustrating a computer networking system adapted to an apparatus for providing a seamless interoperability between a web browser and an application in a single-threaded environment in accordance with an embodiment of the present invention. The apparatus includes a user terminal 100, a network 200, and a web service server 300.

As illustrated in FIG. 1, the user terminal 100 is a multimedia device for providing a user with the seamless interoperability between a web browser and an application in the single-threaded environment, and may be various types of terminals such as a video phone, a smart phone, a notepad, a laptop computer, and a tablet computer.

The user terminal 100 provides a broadband communication service and a short distance communication service to subscribers via the network 200. The user terminal 100 includes an application driver 102, a user interface unit 104, and a memory unit 106. The memory unit 106 includes an application 12 and a web browser 14 which are installed within the user terminal 100.

The web browser 14 as a program installed in the user terminal 100 serves to provide a web service to a user via the user interface unit 104. The web browser 14 may have a plurality of tabs, and load one or more web pages on each tab. As is well known in the art, however, only one web page is activated and the rest is stopped operating at one point of time in the web browser. The stopped web page may be activated automatically or by manual and the previously activated web page is then inactivated. In the present embodiment, it is assumed that two tabs, e.g., a first tab 14a and a second tab 14b are used in the web browser 14, as shown in FIG. 2.

The user interface unit 104 performs communication with the web service server 300 and executes the application driver 102. Furthermore, the user interface unit 104 executes the web browser 14 and the tabs 14a and 14b in the web browser 14.

The user interface unit 104 may execute, through the first tab 14a in the web browser 14, the application driver 102 to call the application 12, receive on the second tab 14b a response of the application 12, and deliver the response to the web service server 300. Further, the user interface unit 104 terminates the second tab 14b and activates again the first tab 14a to request the web service server 300 to send a result page onto the first tab 14a.

The application driver 102 receives a parameter from the web service server 300 via the user interface unit 104 and drives the application 12 in the memory unit 106.

Then, the application 12 driven by the application driver 102 returns the response corresponding to the parameter to the application driver 102. This response is then transmitted to the web service server 300 via the second tab 14b of the web browser 14.

The web service server 300 provides a web service to the user terminal 100 on request of the user terminal 100. The web service server 300, when having received a request for a service from the first tab 14a in the web browser 14 of the user terminal 100, requests the user terminal 100 to transmit execution result information of a specific application 12 and delivers a specific parameter together thereto.

Moreover, the web service server 300, when receiving a response (the execution result information) of the specific application 12 from the second tab 14b in the web browser 14 of the user terminal 100, handles the response and returns a script for closing the second tab 14b to the user terminal 100.

The web service server 300, when the service is again requested from the first tab 14a in the web browser 14, checks the response from the application 12 and provides the service onto the first tab 14a of the user terminal 100.

The network 200 may include a broadband network and a short distance network. Herein, the broadband network includes a wireless broadband network and a wired broadband network.

The wireless broadband network guarantees mobility of the user terminal 100 and may have a function of managing handover and wireless resources. The wireless broadband network includes a base station and a base station controller, and supports both a synchronous manner and an asynchronous manner. The wireless broadband network may provide a wireless communication service supporting the second-generation communication based on CDMA (Code Division Multiple Access), the third-generation communication based on WCDMA (Wideband Code Division Multiple Access), and a subsequent generation communication. The wireless broadband network is, however, not limited to that, and may include a GSM (Global System for Mobile communications) network and any kind of access networks of mobile communication systems to be implemented in the future.

The wired broadband network provides a wired communication service supporting IP (Internet Protocol) based-communication technology such as the Internet, and provides an environment allowing the user terminal 100 to be connected to the web service server 300. The wired broadband network has a worldwide open computer network structure providing TCP/IP (Transmission Control Protocol/Internet Protocol) and various services of upper layers, such as, HTTP (Hyper Text Transfer Protocol), HTTPS (HTTP over Secure Socket Layer), FTP (File Transfer Protocol), DNS (Domain Name System), SMTP (Simple Mail Transfer Protocol), SNMP (Simple Network Management Protocol), NFS (Network File Service), and NIS (Network Information Service).

The short distance network in the network 200 includes a wired local area network (LAN) and a wireless local area network (WLAN).

The LAN provides a short distance wired communication environment between the user terminal 100 and the web service server 300. The WLAN provides a short distance wireless communication environment such as Wi-Fi between the user terminal 100 and the web service server 300.

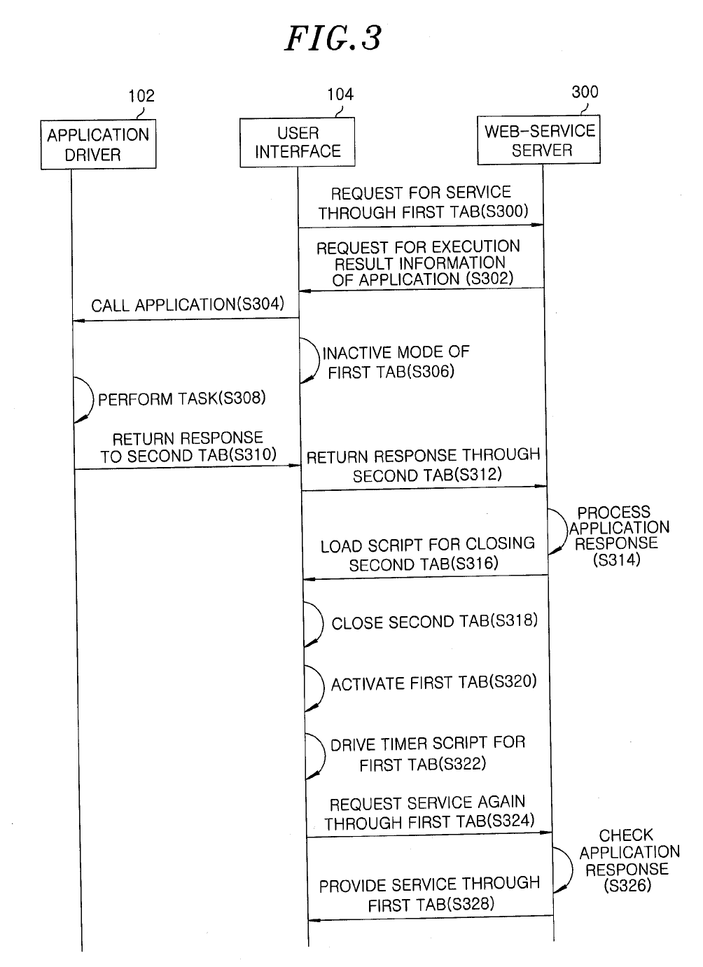

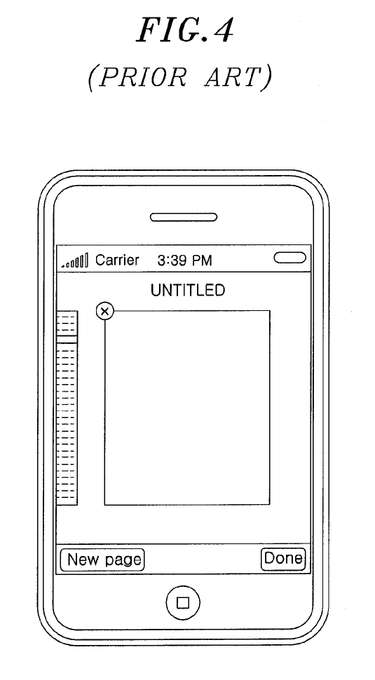

Hereinafter, a method of providing seamless interoperability between a web browser and an application in the single-threaded environment will be described in detail with reference to a sequence diagram of FIG. 3.

FIG. 3 is a sequence diagram illustrating the seamless interoperability between the web browser and the application in the single-threaded environment by a user terminal 100 in a computer networking system in accordance with the embodiment of the present invention.

As illustrated in FIG. 3, first, the user interface unit 104 of the user terminal 100 requests, through the first tab 14a in the web browser 14, the web service server 300 to provide a specific service in step S300.

The web service server 300 which has received the request from the user interface unit 104 requests execution result information of a specific application 12 of the user terminal 100 and simultaneously transmits a specific parameter to the user interface unit 104 of the user terminal 100 in step S302.

After that, the user interface unit 104 executes the application driver 102 to call the application 12 while transmitting the parameter from the web service server 300 to the application driver 102 in step S304.

The following script is an example of a web page transmitted from the web service server 300 to the web browser 14 via the user interface unit 104 in the above step S302.

```
[Web page 1]
...
<script type=“text/javascript”>
function run( ) {
  win1 = window.open(“smartsign://{params}”);
  ...
}
...
</script>
...
```

In the [Web page 1], when a javascript function “run( )” is executed, a new window is opened and a web page called “smartsign:// . . . ” is opened in the window. An application matched to an URL scheme called “smartsign” is driven and a string positioned at “{params}” is transmitted as an input parameter of the application.

Meanwhile, when the user interface unit 104 has called the application 12 in step S304, the first tab 14a in the web browser 14 is switched to an inactive mode in step S306 and the application 12 is activated and executed. These steps may be automatically processed in the single-threaded environment.

The application driver 102 performs a specific task corresponding to the parameter using the activated application 12 in step S308 and returns a response of the application 12 onto the second tab 14b in the web browser 14 in step S310. Since the response is transmitted, e.g., in a URL form to the web service server 300 via the web browser 14, the web browser 14 is activated by the user interface unit 104 and the application 12 is switched to an inactive mode by the application driver 102. The first tab 14a of the activated web browser 14 is still in an inactive state and the second tab 14b is created, so that the response can be returned to the second tab 14b. These steps may be automatically processed in the single-threaded environment.

After that, the user interface unit 104 transmits the response from the second tab 14b to the web service server 300 in step S312.

Then, the web service server 300 handles the response of the application 12 and prepares a service to provide to the user terminal 100 in step S314.

Next, the web service server 300 return a script for closing the second tab 14b to the user terminal 100 in step S316.

The following script is an example of information of a web page transmitted from the web service server 300 onto the web browser 14 of the user interface unit 104 in step S316.

[Web page 2]
<html>
<head>
<script type=“text/javascript”>
function run( )
{
close ( ) ;
}
</script>
</head>
<body onload=“javascript:run( );”>
</body>
</html>

In the [Web page 2], when a web page is loaded by means of the phrase “<body onload=”javascript:run( )“>”, a javascript function called “run( )” is immediately executed. The javascript function “run( )” closes a present tab by executing the close( ). That is, as soon as the web page is loaded, a corresponding tab is closed.

Therefore, once the script is executed, the user interface unit 104 can close the second tab 14b in the web browser 14 in step S318.

When the second tab 14b is closed, the user interface unit 104 switches the mode of the first tab 14a into an active mode in step S320. The active mode may be automatically processed in the single-threaded environment.

In step S322, the user interface unit 104 drives a timer script in the first tab 14a, which is a subsequent script from a point of the calling of the application 12 in the above step S304.

The timer script is periodically called, and automatically performs a specific function when a preset condition is satisfied. Through the timer script, the service that the user interface unit 104 requested via the first tab 14a to the web service server 300 in the above step S300 can be requested again in step S324.

The following script is an example of a web page containing the timer script.

```
  [Web page 3]
  <script type=“text/javascript”>
  function run( ) {
    win1 = window.open(“smartsign://{params}”);
    reload(1);
  }
  function reload(cnt) {
    document.getElementById(“DIV_COUNT”).innerHTML =
cnt + “<BR>”;
    setTimeout(“reload(“+ ++cnt +”)”, 1000);
    if (cnt >2)
    {
    location.href=“http://129.254.186.19:8080/smartsign/service.jsp”;
    }
  }
  </script>
```

In the web page 3, a javascript function “reload( )” is executed after an application “smartsign” is driven in the javascript function “run( )” This javascript function “reload” may be called using a javascript function called “setTimeout( )” every preset time, e.g., every one second. An if-phrase of the “reload( )” function may be satisfied two seconds later and a corresponding tab may be automatically shifted to an address assigned to “location.href” according to the above-mentioned web page.

When receiving the request for the service again from the user interface unit 104, the web service server 300 checks the response of the corresponding application 12 in step S326. Thereafter, the web service server 300 delivers the service to the user interface unit 104, and the user interface unit 104 provides the user with the service through the first tab 14a in the web browser 14 in step S328.

As described above, the present invention provides a seamless interoperability between a web browser and an application in a single-threaded environment. Further, the web browser drives an application on one tab and can reload, on the same tab, a web page corresponding to a response from the application. Thus, the present invention can solve a phenomenon that stopped taps are accumulated in the web browser and users have to close the accumulated stopped tabs one by one by manual, while carrying out an operation reflecting the response of the application. Moreover, due to a use of standard javascript, neither a separated module nor a correction is required.

While the invention has been shown and described with respect to the embodiments, it will be understood by those skilled in the art that various changes and modification may be made without departing from the scope of the invention as defined in the following claims.

What is claimed is:

1. An apparatus for providing a seamless interoperability between a web browser and an application in a single-threaded environment in a user terminal, the apparatus comprising:
a web service server configured to provide a web service via a network, based on the seamless interoperability between the web browser and the application; and
a user terminal configured to receive a parameter for the web service in communication with the web service server via the network, call the application onto a first tab in the web browser, receive a return response of the application onto a second tab in the web browser to transmit the received return response to the web service server, and request the web service server to provide a result web page while executing the first tab when the second tab is closed.

2. The apparatus of claim 1, wherein the web service server, in response to a request for the web service from the first tab of the user terminal, is further configured to request the user terminal to transmit execution result information of the application, and transmit the parameter to the user terminal.

3. The apparatus of claim 1, wherein the web service server, in response to the return response of the application from the second tab of the user terminal, is further configured to handle the return response of the application and return a script for closing the second tab to the user terminal.

4. The apparatus of claim 1, wherein the web service server, in response to the request for the web service requested from the first tab once more, is further configured to check the return response of the application and provide the web service onto the first tab of the user terminal.

5. The apparatus of claim 1, wherein the user terminal includes:
a user interface unit configured to communicate with the web service server and execute the web browser, the first tab, and the second tab; and
an application driver configured to receive the parameter from the web service server via the user interface unit and drive the application in accordance with to a command from the user interface unit.

6. The apparatus of claim 1, wherein the parameter includes a Javascript.

7. The apparatus of claim 1, wherein the network includes a broadband communication network and/or a short distance communication network.

8. A method for providing a seamless interoperability between a web browser and an application in a single-threaded environment in a user terminal, the method comprising:
requesting a web service through a first tab in the web browser;
calling the application when receiving a request for execution result information of the application;
stopping the execution of the first tab;
returning a response of the application through a second tab in the web browser;
activating the first tab after closing the second tab; and
requesting the web service through the first tab once more.

9. The method of claim 8, wherein a parameter for executing the application is received together with the reception of the request for the execution result information of the application.

10. The method of claim 9, wherein said calling the application includes transmitting the parameter in order to drive the application.

11. The method of claim 8, wherein said closing the second tab is performed by receiving a script for closing the second tab.

12. The method of claim 11, wherein the script includes a Javascript.

13. The method of claim 8, further comprising:
receiving the web service through the first tab after said requesting the web service through the first tab once more.

14. A method for providing a seamless interoperability between a web browser and an application to be executed in a single-threaded environment by a user terminal in a computer networking system including the user terminal and a web service server, the method comprising:
receiving a request for a web service from a first tab in the web browser of the user terminal;
requesting execution result information of the application to the user terminal;
receiving a response of the application from a second tab in the web browser of the user terminal to handle the response of the application;
transmitting a script for closing the second tab to the user terminal; and
checking the response of the application when the web service is again requested from the first tab of the user terminal.

15. The method of claim 14, further comprising:
providing the web service onto the first tab of the user terminal.

16. The method of claim 14, wherein the script includes a Javascript.
